(19) United States
(12) Patent Application Publication
(10) Pub. No.: US 2005/0251465 A1
(43) Pub. Date: Nov. 10, 2005

(54) System and method for structuring and operating an investment vehicle

(76) Inventors: Daniel P. Brown, Wauwatosa, WI (US); David W. Schulz, Mequon, WI (US); David Abitz, Redding, CA (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 11/115,535

(22) Filed: Apr. 27, 2005

Related U.S. Application Data
(60) Provisional application No. 60/567,485, filed on May 2, 2004.

(51) Int. Cl. G06F 17/60

(52) U.S. Cl. 705/35

(57) ABSTRACT

A system and method of structuring and operating an investment vehicle is disclosed which structures the investment vehicle as a common trust fund which operates using the investment, trading, and timing strategies of a hedge fund. The investment vehicle is implemented using a common trust fund structure, which may be offered by a financial institution. The investment vehicle so operated by the financial institution using a hedging strategy to manage the property from the trust to achieve a strong return, even in adverse market conditions.

### IDENTIFICATION OF RELATED PATENT APPLICATION

This patent application claims the benefit of U.S. Provisional Patent Application No. 60/567,485 (the '485 application), filed on May 2, 2004, entitled “System and Method for Structuring and Operating an Investment Vehicle,” which is assigned to the assignee of the present invention, and which is hereby incorporated herein by reference in its entirety.

### BACKGROUND OF THE INVENTION

Field of the Invention

The present invention relates generally to investment funds, and more particularly to a system and method of structuring and operating an investment vehicle which is structured as a common trust fund which operates using the investment, trading, and timing strategies of a hedge fund.

Investment is the considered purchase of assets, or rights, with the expectation that these assets will increase in value at some future point in time. Investing as an individual investor requires that the individual be willing to put in a considerable amount of personal time to understand the market in which the investment is to be made, both to increase the probability of a positive return, and to decrease the investment risk. While some people are comfortable (and capable) of investing directly, others recognize their limitations and seek the assistance of qualified professionals (e.g., accountants, financial planners, or money managers managing mutual or hedge funds).

A mutual fund pools a group of investors' money in order to reach a total investment of a size suitable for the purchase of stocks, bonds, or other financial instruments in amounts that are sufficient for effective diversification. With mutual funds, the more different stocks or bonds the investor owns, the less any one of them can negatively affect the investor. A mutual fund investment is also completely liquid, meaning that the investor can get in or out simply by using the telephone or the computer to buy or sell. Mutual funds are managed by professional money managers and have their own respective investment mandates. When an individual invests in a fund, that individual is actually purchasing units (or a portion) of the fund and is entitled to participate in any gains or losses realized by the fund. Each mutual fund investor, known as a unit holder, also pays a share of the mutual fund's total expenses.

A hedge fund, on the other hand, is a pooled investment vehicle that is privately organized and is actively managed by highly compensated professional investment managers. It is different from other pooled investment funds such as mutual funds in that access is available only to wealthier “accredited” investors. Hedge funds are allowed to use aggressive strategies that are unavailable to mutual funds, including short selling, leverage, program trading, swaps, arbitrage, and derivatives, all of which are consistent with their objective of obtaining a consistently above-average return under all market conditions, although at a higher risk. Hedge funds also keep their investments and investment strategies secret, with the investors typically having no idea what the investment strategy of the operator of the hedge fund is.

Hedge fund operators are compensated based upon the performance of the fund they administer, with most hedge funds charging both a fixed annual cost (typically one or two percent of net assets) plus a percentage of the annual return (typically approximately twenty percent). Hedge funds usually require investors to make a large fixed investment (i.e., one hundred thousand dollars or more typically one million dollars) and only allow withdrawals at certain times of the year (typically annually but no more frequently than quarterly).

In the U.S., hedge funds are exempt from Securities and Exchange Commission (“SEC”) reporting requirements, as well as from regulatory restrictions concerning leverage or trading strategies. Hedge funds are not required to be registered in any way with the SEC or any other securities agency (at least not on the federal level). Operators of a hedge funds are not brokers or dealers, since they do not buy or sell securities for others or receive commissions for such sales. Technically, hedge funds are investment companies, but pursuant to exemptions contained in the Investment Company Act of 1940, they are exempt from the registration requirements thereunder.

The creation and establishment of a hedge fund involves three steps, the first of which is the creation of a limited partnership or a limited liability corporation in order to provide the investment vehicle for the investments to be made by the investors. The second step is the creation of a Private Placement Memorandum which explains trading strategies and risks and provides information about the key personnel and the limited partnership or limited liability corporation. The third step is having Subscription Agreements which are signed by the investors in the limited partnership or limited liability corporation.

Hedge funds are not subject to registration with the SEC so long as they conform to one of three requirements, the first of which is the Regulation D exemption of the Securities Act of 1933. This exemption requires all but 35 holders of the securities to be “accredited holders” (persons having a net worth in excess of one million dollars or an annual income of two hundred thousand dollars (three hundred thousand dollars joint income with a spouse) and an expectation off earning the same in the current year, and that the securities are privately placed. The other two requirements are Section 3(c)1 or Section 3(c)7 of the Investment Company Act of 1940, both of which require that the fund cannot make a public offering of its securities or hold itself out to the public as an Investment Advisor. Section 3(c)1 requires that the fund have under one hundred beneficial owners and that they be accredited investors (net worth in excess of one million dollars), and Section 3(c)7 requires that the fund have five hundred super-qualified beneficial investors (net worth in excess of five million dollars).

Thus, it may be seen that these investor limitations in the regulations regarding hedge funds exclude the vast majority of prospective investors entirely from participation in hedge funds. As such, most investors are limited to mutual funds or investments in individual securities. In addition, even those investors who are financially able to participate in hedge funds are unable to monitor the operation of the hedge funds, since the investment strategy is known only to the operator of the hedge fund. While hedge funds as a class provide a better return than mutual funds do, particularly in a down market, there are occasions when hedge funds have “melted down,” with investors losing substantially their entire investment through investment strategies that the investors would have likely sought to avoid had they known of the hedge fund's investment strategy.

It is accordingly the primary objective of the present invention that it provide an investment vehicle which offers the financial performance advantages of a hedge fund, but allows smaller investors to participate in the investment vehicle. It is a related objective of the investment vehicle of the present invention that it offer a high level of performance in a wide variety of market conditions, such that it will typically outperform mutual funds, particularly in a down market. It is another related objective of the investment vehicle of the present invention that it not be restricted to accredited investors or qualified purchasers, but rather that it allow smaller investors as well as larger investors to participate.

It is a further objective of the investment vehicle of the present invention that it provide an investment strategy which is more transparent than the strategies of typical hedge funds, thereby allowing investors to make a more educated investment decision. It is a yet further objective of the present invention that it offer a higher degree of liquidity than typical hedge funds which allow only annual withdrawals. It is a still further objective of the investment vehicle of the present invention that it comply with Federal regulatory requirements, including the Securities Act of 1933 and the Investment Company Act of 1940, and with state regulatory requirements. It is a related objective of the present invention that it be implemented using a common trust fund structure which may be offered by a bank, thereby allowing the investment vehicle of the present invention to be advertised in conjunction with ordinary advertising of a bank's fiduciary services.

The investment vehicle of the present invention should be relatively straightforward to implement by a bank or other financial institution while providing the financial institution with an performance-based fee structure. In order to enhance the market appeal of the investment vehicle of the present invention, it should offer an advantageous investment opportunity to potential investors to thereby afford it the broadest possible market. Finally, it is also an objective that all of the aforesaid advantages and objectives of the investment vehicle of the present invention be achieved without incurring any substantial relative disadvantage.

### SUMMARY OF THE INVENTION

The disadvantages and limitations of the background art discussed above are overcome by the present invention. With this invention, an investment vehicle is provided which presents the benefits of a hedge fund. The investment vehicle of the present invention takes the form of a common trust fund which is managed by a financial institution, such as a bank or a trust company, which acts as the trustee of the common trust fund and is authorized to invest trust properties using a hedging strategy which pursues market level returns over longer periods of time. This hedging strategy is designed to provide a rate of return which is independent of market returns, typically outperforming the market, particularly at times when the market is in a downturn.

By using a common trust fund as the investment vehicle of the present invention instead of using a limited partnership as in the case of a hedge fund, the general public is allowed to invest in the investment vehicle of the present invention. This is because common trust funds are exempt from the registration requirements of the Investment Company Act of 1940 under Section 3(c)3, since: 1. the fund is used to facilitate the administration of trusts; 2. the fund is only advertised and offered for sale to the public in connection with the ordinary advertising of fiduciary services; and 3. the fees and expenses charged by the fund do not violate any federal or state law. The offer and sale of the trust are also exempted from the registration and prospectus delivery requirements of the Investment Company Act of 1940.

In the preferred embodiment, the present invention provides a system and method for structuring an investment vehicle which is implemented by first creating a common trust fund to be used by the financial institution as a vehicle to pool property from a plurality of trusts. Next, a disclosure statement and a trust agreement are prepared and submitted to potential investors for their consideration. The investors then executing trust agreements and provide capital to the financial institution to establish trusts with the financial institution as the trustee and transfer capital into the trusts, which capital is pooled and invested in the common trust fund.

The trust agreement used in the present invention can be either a revocable or an irrevocable trust agreement. The trustee of the trust can (and preferably does) have broad discretionary trust powers to select, retain, invest, re-invest, manage, exchange, and dispose of the trust property. The common trust fund is managed using a hedging-like strategy to manage the pooled properties from the trusts. Periodically, and preferably monthly, the portfolios of the common trust fund are rebalanced.

In the preferred embodiment, the hedging strategy used to manage the investment vehicle of the present invention includes holding both a long-term portfolio and a short-term portfolio. The long-term portfolio involves the ownership of securities (a long position) and is constructed using statistical measures historically associated with rising values. The short-term portfolio involves the short sales of securities (going short), which is the sale of securities which are borrowed and not owned with the expectation of purchasing the security (to replace the borrowed security) at a later date at a lower price, and is constructed using statistical measures associated with declining values.

It will thus be appreciated by those skilled in the art that the preferred investment strategy combines long and short positions to benefit from both undervalued and overvalued securities. As such, the investment strategy of the investment vehicle of the present invention is non-directional in that it exploits anomalies in asset prices to thereby focus on security selection. For this reason, the investment vehicle of the present invention is not reliant on the direction of markets. By going long on undervalued securities and going short on overvalued securities, the investment vehicle of the present invention earns a return from both the long and short positions if the securities behave as expected. This non-directional strategy often displays a low correlation to the market, and thus can result in a good return for the investors without excessive risk.

It may therefore be seen that the present invention teaches an investment vehicle which offers the financial performance advantages of a hedge fund, but allows smaller investors to participate in the investment vehicle. The investment vehicle of the present invention offer a high level of performance in a wide variety of market conditions, such that it will typically outperform mutual funds, particularly in a down market. The investment vehicle of the present invention is not restricted to accredited investors or qualified purchasers, but rather allows smaller investors as well as larger investors to participate.

The investment vehicle of the present invention provides an investment strategy which is more transparent than the strategies of typical hedge funds, thereby allowing investors to make a more educated investment decision. It offers a higher degree of liquidity than typical hedge funds which allow only annual withdrawals. The investment vehicle of the present invention complies with Federal regulatory requirements, including the Securities Act of 1933 and the Investment Company Act of 1940, and with state regulatory requirements. It is implemented using a common trust fund structure which may be offered by a bank, thereby allowing the investment vehicle of the present invention to be advertised in conjunction with ordinary advertising of a bank's fiduciary services.

The investment vehicle of the present invention is relatively straightforward to implement by a bank or other financial institution, and provides the financial institution with an performance-based fee structure. The investment vehicle of the present invention offers an advantageous investment opportunity to potential investors, thereby enhancing its market appeal and affording it the broadest possible market. Finally, all of the aforesaid advantages and objectives of the investment vehicle of the present invention are achieved without incurring any substantial relative disadvantage.

### DESCRIPTION OF THE DRAWINGS

These and other advantages of the present invention are best understood with reference to the drawings, in which:

FIG. 1 is a schematic block diagram illustrating the operation of a hedge fund;

FIG. 2 is a schematic block diagram illustrating the operation of common trust fund which is operated according to the teachings of the present invention to practice a non-directional investment strategy;

FIG. 3 is a schematic block diagram illustrating the establishment of a trust which may be utilized in the common investment vehicle system shown in FIG. 2;

FIG. 4 is a process flowchart illustrating the operation of the investment vehicle system shown in FIG. 2; and

FIG. 5 is an illustration showing several of the factors utilized in establishing the long and short strategies used by the investment vehicle system

### DETAILED DESCRIPTION OF THE PREFERRED EMBODIMENT

The preferred embodiment of the present invention is an investment vehicle which takes the legal form of a common trust fund and presents the benefits of a hedge fund by simultaneously taking long and short positions using a non-directional investment strategy. The common trust fund is managed by a financial institution and is available to smaller investors and a larger number of investors than a traditional hedge fund which is established as a limited partnership or a limited liability corporation. By using the non-directional investment strategy, the investment vehicle of the present invention obtains returns over long periods of time which are consistent and are largely independent of the market, with a relatively low level of risk. In order to better explain the operation of the investment vehicle of the present invention, the following brief discussion of the operation of a hedge fund is helpful.

A hedge fund is a private investment pool that is subject to far less regulatory oversight than a mutual fund. Hedge funds are designed to provide a distinctly different risk/return profile from traditional long-only investment strategies (e.g., mutual funds). A hedge fund is a pooled investment vehicle that is privately organized and is also administered by professional investment managers. Hedge funds are commonly structured as limited partnerships in which the investment manager, or the investment manager's capital management company, acts as the general partner while the investors act as the limited partners.

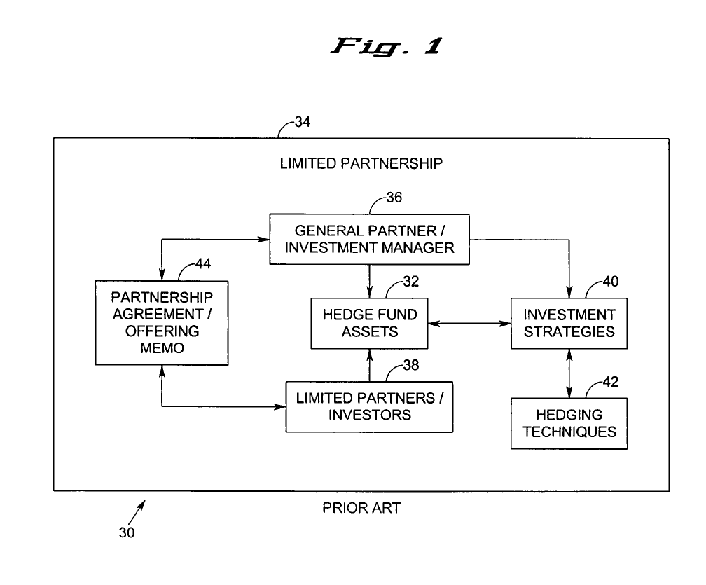

Referring to FIG. 1, a hedge fund 30 serves to invest the partners' funds as trust assets 32 according to any of a number of strategies. The hedge fund 30 is typically structured as a limited partnership 34 in which the investment manager acts as a general partner 36 while the investors are limited partners 38. The general partner 36 thus determines the investment strategy 40 which will be used to manage the hedge fund 30. The hedge fund 30 is allowed to employ these various non-directional hedging techniques 42 (unlike mutual funds which are directional) because the SEC does not strictly regulate the choice of investments used by hedge funds so long as they otherwise comply with the law. The general partner 36 can invest the assets of the limited partners 38 according to any strategy, as long as it is in accordance with a partnership agreement and offering memorandum, generally indicated by the reference numeral 44.

Hedging funds may involve the selection of an element of the market (e.g., bank stocks) or the U.S. market as a whole, with the investment strategy designed both to invest in the chosen area and also to protect the invested assets from potentially weak investment cycles in the selected area. For example, the investment manager of a hedge fund may hedge market risk by investing a large portion of the assets of the fund in semiconductor manufacturing stocks (going long), but at the same time purchase some put (sell) options on the semiconductor stocks (going short) in case the semiconductor market performs poorly. If in fact the semiconductor market does perform poorly, the manager's “insurance” has protected the portfolio from the larger loss the manager would have incurred without hedging.

The Mechanics of a Common Trust Fund

The present invention uses a common trust fund as an investment vehicle to structure an investment fund in a way that allows the investment fund both regulatory freedom and access to the general public, thereby combining the advantages of mutual funds and hedge funds, without incurring any substantial disadvantage. The common trust fund of the present invention includes a group of investments set aside by the trustee for investment by a plurality of trusts operated by the trustee. The present invention may be used by banks and other financial institutions, and does not require the establishment of an independent business entity. By using a common trust fund structure, the investments of the plurality of trusts are diversified, thus spreading the risk of loss, and making it easy to invest any amount of trust funds. Thus, the present invention utilizes a pooled investment vehicle similar to those of mutual funds and hedge funds, but without encountering the problematic SEC regulations affecting hedge funds and thereby providing increased access to the general investing public.

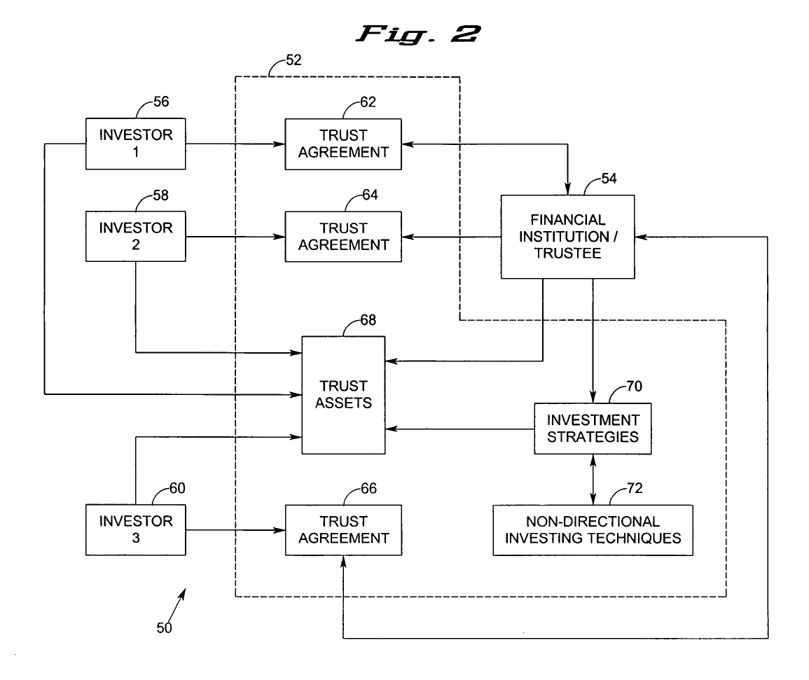

Referring next to FIG. 2, there is shown a diagram of an investment vehicle system 50 which is constructed according to the principles of the present invention, including a common trust fund 52. The investment vehicle system 50 includes a trustee 54, which is a financial institutions such as a banks or a trust company. In the investment vehicle system 50 illustrated in FIG. 2, three investors 56, 58, and 60 are illustrated, although those skilled in the art will appreciate that there may be many more investors, since due to the structure of the investment vehicle system 50 used by the present invention, there are no regulatory limitations on the number of investors that can participate.

The common trust fund 52 also illustrates three trust agreements 62, 64, and 66, which are established by and between the trustee 54 and the three investors 56, 58, and 60, respectively. After the trust agreements 62, 64, and 66 have been established, the three investors 56, 58, and 60 deposit capital to establish trust assets 68. The trustee 54 holds the trust assets 68, and has a fiduciary responsibility to administer and manage the trust assets 68. The trustee 54 also determines the investment strategy 70 which will be used to manage the trust fund 68, and will employ non-directional investing techniques 72, examples of which techniques will be discussed below.

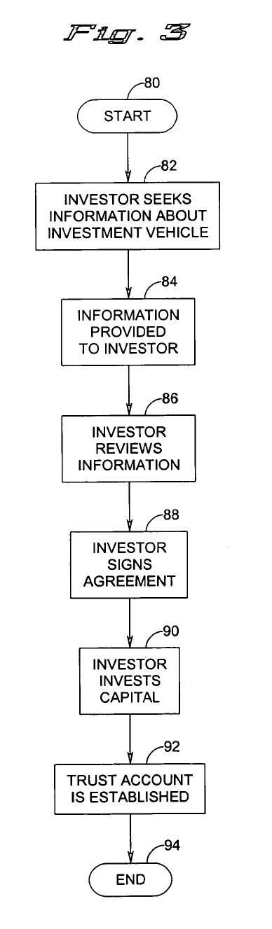

Referring now to FIG. 3, an example of how a trust such as the three shown in FIG. 2 which will participate in the common trust fund 52 (shown in FIG. 2) can be established. From a process initiation step 80, the process moves to an information seeking step 82 in which a potential investor seeks information about the investment vehicle system 50 (also shown in FIG. 2). Next, information is provided by the financial institution operating the investment vehicle system 50 to the potential investor in a provide information step 84. The information provided will preferably include disclosure documents describing the investment vehicle as well as a trust agreement. The investor will review the provided information in a review information step 86.

If the investor desires to establish a trust on the terms provided in the information furnished by the financial institution, the investor will execute the trust agreement in a sign agreement step 88. Next, the investor will provide capital to the financial institution to invest in the common trust fund in an invest capital step 90. The completion of the sign agreement step and the invest capital step will result in the creation of a trust between the investor and the financial institution, as indicated by the trust established step 92, following which the process terminates in a process completion step 94.

In the preferred embodiment, the agreements between investors and the trustee give the trustee the sole discretion and power to select, retain, invest, re-invest, manage, exchange, and dispose of the trust property, including short selling, leverage, program trading, swaps, arbitrage, and derivatives. The trustee 102 is empowered to do any act which it considers to be in the best interest of the trust. Typically, the agreement will indicated that the trustee shall not be liable for any error in judgment, or for any loss resulting from the exercise of any discretionary power conferred upon it in connection with administering the trust.

In the preferred embodiment, investors have limited liquidity because withdrawals are permitted only at the end of each calendar quarter on at least ten days' advance notice. While this restriction is acceptable to those who do not need immediate liquidity with respect to their assets, it will be appreciated by those skilled in the art that more frequent withdrawals could require the trust to sell securities or liquidate positions at a loss or at unfavorable prices. The agreement establishing the trust may also outline other provisions, such as investment responsibilities, investment services, trustee's powers and duties, and provisions relating to distributions and terminations.

In the preferred embodiment, the investment vehicle of the present invention utilizes an incentive fee-based fee structure. This enables the trustee to draw upon the best talent in the financial world. Since talent, or at least performance, is rewarded, while ineptitude is not, the most talented money managers will gravitate towards the investment vehicle of the present invention. By way of example, the trustee may charge a monthly management fee equal to approximately 0.0833% (or one percent annually) of the trust's net assets as of the end of each calendar month. Generally, the range for the management fee may vary between approximately one-half percent and three percent annually. Also by way of example, the trustee may also charge an annual incentive fee equal to approximately ten percent of the net appreciation in the value of the trust account during each calendar year. Generally, the range for the annual incentive fee may vary between about five percent and twenty percent of the net appreciation in the value of the trust.

In calculating net appreciation, all realized and unrealized gains, losses, appreciation, depreciation, and costs, fees, and expenses are preferably considered, but net appreciation or depreciation due to additional capital contributions and withdrawals is preferably disregarded. The net appreciation is also preferably determined after deducting the management fee but before the incentive fee is determined; For purposes of establishing the beginning value of each trust for a given year, the value of the trust after deducting the incentive fee (if any) attributable to the immediately preceding year is preferably used.

In the preferred embodiment, the incentive fee for a given year will generally be levied in January of the following year. However, upon a withdrawal of capital during the year, the incentive fee attributable to that account for the stub period is assessed on the amount withdrawn. Preferably, hurdles or high water marks are not associated with the incentive fee. As a result, if a trust with an initial balance of $10,000,000 on January 1 declines in value to $8,000,000 on December 31 of that same year, no incentive fee will be paid (because there was no appreciation). However, if on December 31 of the following year the value of the trust has increased in value to $9,000,000, a performance fee of $100,000 will be paid on the $1,000,000 appreciation over the value as of the end of the previous year even though the value of the trust ($9,000,000) remains less than the initial balance of $10,000,000.

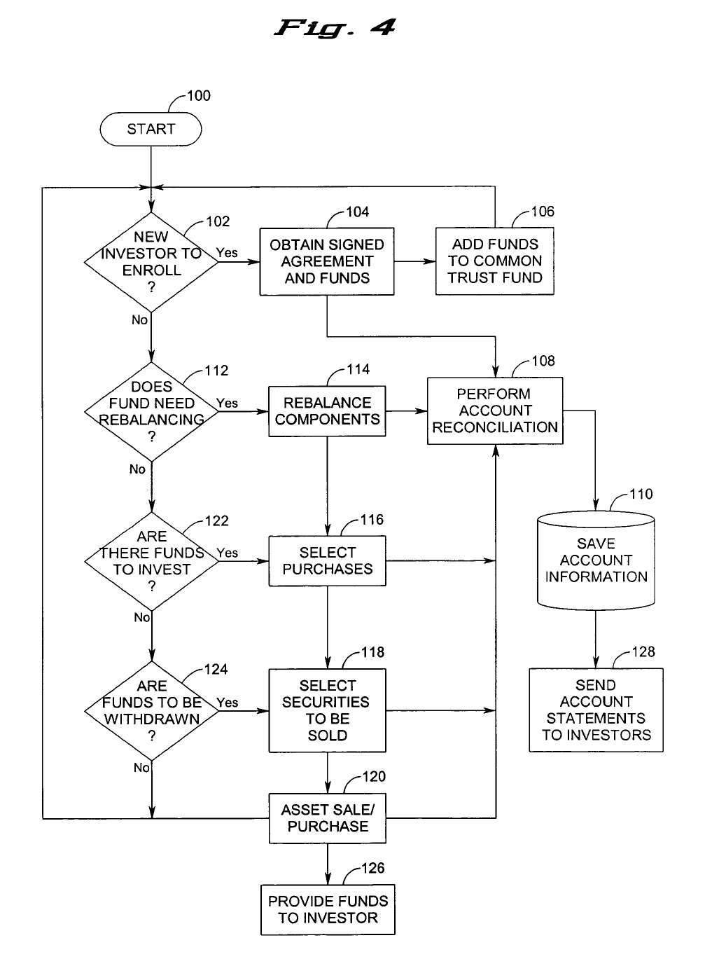

Turning now to FIG. 4, a high-level process diagram of the operation of the investment vehicle of the present invention is shown. The process begins at a process initiation step 100, and moves first to an enrollment determination step 102 in which it is determined if there is a new investor to enroll in the investment vehicle. If there is the process moves to an obtain agreement and funds step 104, in which a signed agreement and funds have been provided from a new investor. The funds are added to the common trust account, and the process returns to the enrollment determination step 102. Additionally, the information about the new investor and the funds provided by the new investor are sent to an account reconciliation step 108 in which the account from the new investor is created and updated, with the data then being stored in a database 110.

Returning again to the enrollment determination step 102, if, on the other hand, there is no new investor to enroll, the process moves to a rebalancing determination step 112 in which a determination is made as to whether the common trust fund needs to be rebalanced. If a determination is made that the common trust fund needs to be rebalanced to ensure integrity of the investment strategy and reduce the net risk to changing market conditions, the process moves to a rebalance components step 114 in which the components of the common trust fund are rebalanced, and buy and sell information is generated. This information is provided to the account reconciliation step 108, with the data then being stored in the database 110.

Additionally, the process moves to a select purchases step 116 in which the system will select securities to be purchased, following which the process moves to a select sales step 118 in which the system will select securities to be sold. This information is also provided to the account reconciliation step 108, with the data then being stored in the database 110. The process will then move to an asset sale and purchase step 120 in which securities will be bought and sold to rebalance the common stock fund, following which the process will return to enrollment determination step 102. The information regarding sales and purchases is provided to the account reconciliation step 108, with the data then being stored in the database 110.

Returning again to the rebalancing determination step 112, if on the other hand the system determines that rebalancing of the common trust fund is not required, the process will move instead to an investment funds availability determination step 122, in which it is determined whether there are funds which should be used to purchase securities. If it is determined that there are such funds, the process moves to the select purchases step 116 in which the system will select securities to be purchased, following which the process moves to the select sales step 118 and then to the asset sale and purchase step 120 in which securities will be bought with the available investment funds. All pertinent information is provided to the account reconciliation step 108, with the data then being stored in the database 110.

Returning again to the investment funds availability determination step 122, if on the other hand the system determines that there are no available investment funds, the process will move instead to funds withdrawal request determination step 124, in which it is determined whether there are valid requests to withdraw funds from the common trust fund. If it is determined that there are such requests, the process moves to the select sales step 118 and then to the asset sale and purchase step 120 in which securities will be sold to generate the funds required to meet the request for withdrawal. All pertinent information is again provided to the account reconciliation step 108, with the data then being stored in the database 110.

Returning again to the funds withdrawal request determination step 124, if on the other hand the system determines that there are no valid requests to withdraw funds, the process moves instead back to the enrollment determination step 102. Periodically, the system will generate account statements to investors in a generate statements step 128, with the data used to generate the statements being obtained from the database 110.

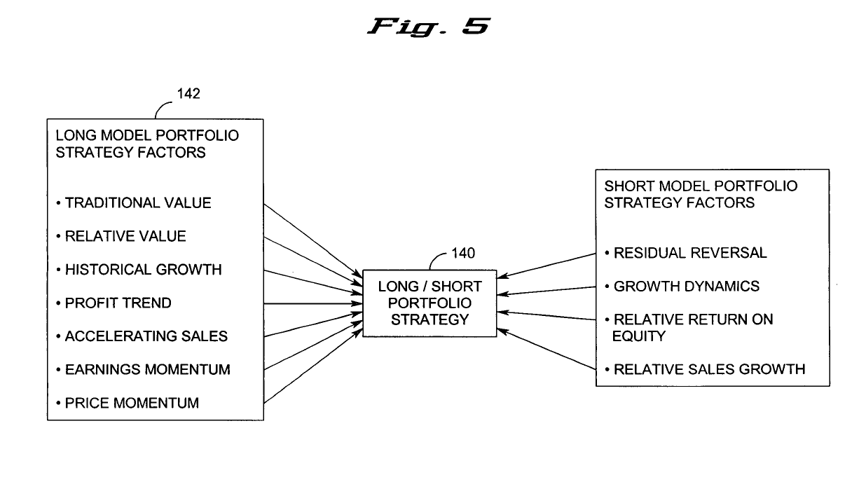

Turning finally to FIG. 5, factors which are used to generate a long/short portfolio investment strategy 140 are shown. The long/short portfolio investment strategy 140 is used to optimize returns over longer periods of time in various market conditions, with an acceptable level of risk. For example, the investment vehicle of the present invention may uses fundamentally based quantitative models using statistical measures that are historically associated with rising and declining values. The long strategy of the preferred embodiment involves holding equal weighted positions in 150-200 stocks of companies within the Russell 1000 Index that the quantitative model indicates have good growth characteristics and are cheaply priced on an absolute and relative basis. To do this, the long model may incorporate, for example, measures of traditional value, relative value, historical growth, profit trends, accelerating sales, earnings momentum, and price momentum.

The short strategy of the preferred embodiment involves the use of two strategies with low correlation to each other. The first strategy uses residual or price reversal measurements to identify as short sale candidates stocks that have experienced recent, unrealistic price appreciation and would be expected to revert to the mean. The second strategy uses fundamentally based, stock-specific factors to predict stocks that are likely to underperform and thus decline in value. In addition, measures of relative return on equity, and relative sales growth are also incorporated into the short model.

A short sale involves the sale of a security that the common trust fund does not own in the expectation of purchasing the same security (or a security exchangeable therefor) at a later date at a lower price. To make delivery of the security sold, the common trust fund borrows the security from a lender and later replaces the borrowed security to the lender, which is accomplished by the purchase of the security by the trust. Since the borrowed security must later be replaced by purchases at market prices to close out a short position, any appreciation in the price of the borrowed security would result in a loss.

A short sale involves the risk of an unlimited loss because the price of the underlying security could theoretically increase without limit, thus increasing the cost of buying that security to cover the short position. Purchasing securities to close out the short position can itself cause the price of the securities to rise further, thereby exacerbating the loss. Also, a short seller may be prematurely forced out of a position due to an inability to maintain a loan of the stock which is borrowed to establish the short. These short-sell risks are well-known in the hedge fund field, but their application to the common trust fund of the present invention is novel. Preferably, the common trust fund short-sells securities that its quantitative model suggests have experienced recent abnormally or unrealistically high appreciation or are otherwise predictive of underperformance.

In addition to the long/short term strategy preferably used by the investment vehicle of the present invention, the common trust fund 108 may also optionally use “leverage” in pursuit of its investment strategy. Leverage according to the present invention generally takes the form of trading on margin and short selling which is inherently leveraged. However, it is preferable that the trust's long positions will not amount to 100% of committed capital and that the value of the securities underlying its short positions will not amount to more than 70% of the long positions. Alternatively, the present invention can acquire “short” securities valuing more than 70% of the long positions.

Modeling may also be done to measure the attractiveness of stocks based on accelerating/decelerating growth and valuation metrics. In addition, on the short side, the common trust fund may incorporates a short-term momentum factor, which attempts to capture short-term reversal patterns in stocks.

In the long/short strategy, the common trust fund may rank stocks within the Russell 1000 Index going back to the mid 1980's and separates the stocks into Z-scores or decile scores to determine each stock's relative attractiveness. Stocks within the lowest ranked scores are considered to be attractive on the predefined model metrics. Conversely, stocks with a high score are considered to be unattractive on these same measures.

Preferably, the long/short portfolio of the common trust fund 108 is set up to use the best Z-scores for the long positions and the worst (decile 10) rankings for the short positions. More particularly, the long portfolio consists of stocks qualifying as a Z-score of 0.25 or greater. However, the entire Energy sector is preferably excluded from the long portfolio (because there is a low level of statistical significance between the preferred model of the present invention and the Energy sector, as the efficacy of the model has proven to be inconsistent over time for the dynamics of the Energy sector).

The short portfolio may includes stocks that are qualified as a decile 10. It is preferable that both the Energy and the Consumer Staples sectors are excluded from this portion of the short portfolio (because there is a low consistency of this model for picking poor performing stocks from these two sectors). In addition, stocks ranked decile 10 from the reversal momentum indicator are also added to the short portfolio.

Each stock within the long portfolio is equal-weighted relative to all qualifying stocks. Fifty percent of the weight for the short comes from the basket of stocks ranked decile 10 on the multifactor model. The other fifty percent of the short portfolio is comprised of stocks within decile 10 of the reversal indicator. Each stock within the short portfolio is equal-weighted relative to its respective basket of stocks.

Finally, the long and short portfolios are preferably rebalanced every month to ensure integrity of stock rankings and also to reduce the net risk to changing market conditions (the stock's relative attractiveness) (i.e., a short position may begin to lose its relative unattractiveness and therefore its relative performance as well as its relative score would improve resulting in an improved score).

It may therefore be appreciated from the above detailed description of the preferred embodiment of the present invention that it teaches an investment vehicle which offers the financial performance advantages of and a hedge fund, but allows smaller investors to participate in the investment vehicle. The investment vehicle of the present invention offer a high level of performance in a wide variety of market conditions, such that it will typically outperform mutual funds, particularly in a down market. The investment vehicle of the present invention is not restricted to accredited investors or qualified purchasers, but rather allows smaller investors as well as larger investors to participate.

The investment vehicle of the present invention provides an investment strategy which is more transparent than the strategies of typical hedge funds, thereby allowing investors to make a more educated investment decision. It offers a higher degree of liquidity than typical hedge funds which allow only annual withdrawals. The investment vehicle of the present invention complies with Federal regulatory requirements, including the Securities Act of 1933 and the Investment Company Act of 1940, and with state regulatory requirements. It is implemented using a common trust fund structure which may be offered by a bank, thereby allowing the investment vehicle of the present invention to be advertised in conjunction with ordinary advertising of a bank's fiduciary services.

The investment vehicle of the present invention is relatively straightforward to implement by a bank or other financial institution, and provides the financial institution with an performance-based fee structure. The investment vehicle of the present invention offers an advantageous investment opportunity to potential investors, thereby enhancing its market appeal and affording it the broadest possible market. Finally, all of the aforesaid advantages and objectives of the investment vehicle of the present invention are achieved without incurring any substantial relative disadvantage.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A method of structuring and operating an investment vehicle, comprising:
establishing a common trust fund for the collective investment of a plurality of investors at a financial institution which acts as the trustee of the common trust fund;
providing a trust agreement for investors to enter with the financial institution the trustee;
entering into at least one trust agreement between at least one investor and the financial institution as the trustee;
allowing the investor to invest capital into the common trust fund; and
actively managing the common trust fund using a hedging strategy to manage the common trust fund.

2. A method as defined in claim 1, further comprising:
periodically rebalancing the portfolios of the common trust fund.

3. A method as defined in claim 1, wherein the hedging strategy comprises:
a long-term portfolio: and
a short-term portfolio.

4. A method as defined in claim 3, wherein the long-term portfolio is constructed using statistical measures historically associated with rising values, and wherein the short-term portfolio is constructed using statistical measures associated with declining values.

5. A method as defined in claim 1, further comprising:
allowing the investor to add additional property to the established trust.

6. A method as defined in claim 1, further comprising:
allowing the investor to withdraw at least a portion of the property held by the established trust.

7. A method as defined in claim 1, further comprising:
allowing a money manager to manage the pooled properties of the common trust fund.

8. A method as defined in claim 1, wherein the trustee is compensated based upon an incentive-based fee.

9. A method of structuring and operating an investment vehicle, comprising:
establishing a common trust fund for the collective investment of a plurality of investors at a financial institution which acts as the trustee of the common trust fund;
providing a trust agreement for investors to enter with the financial institution as the trustee;
entering into at least one trust agreement between at least one investor and the financial institution as the trustee;
allowing the investor to invest capital into the common trust fund;
actively managing the common trust fund using a hedging strategy to manage the common trust fund;
periodically rebalancing the portfolios of the common trust fund;
providing means for investors to invest additional capital into the common trust fund; and
providing means for the investors to withdraw at least a portion of the investor's capital held by the common trust fund.

10. A method as defined in claim 9, wherein the hedging strategy comprises:
a long-term portfolio; and
a short-term portfolio.

11. A method as defined in claim 10, wherein: the long-term portfolio is constructed using statistical measures historically associated with rising values, and the short-term portfolio is constructed using statistical measures associated with declining values.

12. A method as defined in claim 9, further comprising:
allowing a money manager to manage the pooled properties of the common trust fund.

13. A method as defined in claim 9, wherein the trustee is compensated based on an incentive-based fee.

14. A method of structuring and operating an investment vehicle, comprising:
establishing a common trust fund for the collective investment of a plurality of investors at a financial institution which acts as the trustee of the common trust fund;
providing a trust agreement for investors to enter with the financial institution as the trustee;
establishing a trust based upon the trust agreement; and
actively managing the common trust fund using a hedging strategy to manage the property from the trust.

15. A method as defined in claim 14, wherein the hedging strategy pursues market level returns over longer periods of time, with a substantially market level of risk, as defined by the standard deviation of returns, and with a substantially low correlation to market returns.

16. A method of structuring and operating a common trust fund as a hedge fund, comprising:
establishing a common trust fund for the collective investment of a plurality of investors at a financial institution which acts as the trustee of the common trust fund;
executing a trust agreement to establish a trust, the trust agreement naming the financial institution as the trustee, the trust agreement having an investor;
adding capital obtained from the investor to the common trust fund; and
managing the common trust fund using a hedging strategy, the hedging strategy pursuing market level returns over longer periods of time, with a substantially market level of risk and with a substantially low correlation to market returns.
